(19) United States
(12) Patent Application Publication
(10) Pub. No.: US 2026/0024770 A1
(43) Pub. Date: Jan. 22, 2026

(54) BINDER FOR ELECTRODE OF SECONDARY BATTERY THAT COMPRISES SECONDARY BATTERY NEGATIVE ELECTRODE CONTAINING SILICON-BASED ACTIVE MATERIAL, AND USE OF SAME

(71) Applicant: TOAGOSEI CO., LTD., Tokyo (JP)

(72) Inventors: Hiroyuki KAMIMURA, Nagoya-shi (JP); Kenichi YOSHIMORI, Nagoya-shi (JP); Naohiko SAITO, Nagoya-shi (JP); Takashi HASEGAWA, Nagoya-shi (JP)

(73) Assignee: TOAGOSEI CO., LTD., Tokyo (JP)

(21) Appl. No.: 18/995,655

(22) PCT Filed: Jul. 31, 2023
(86) PCT No.: PCT/JP2023/027912

§ 371 Date: Jan. 16, 2025

(30) Foreign Application Priority Data
Aug. 8, 2022 (JP) 2022-126700

(51) Int. Cl. H01M 4/62; C09J 129/04

(52) U.S. Cl. CPC H01M 4/622; C09J 129/04

(57) ABSTRACT

The present invention provides an electrode binder capable of improving toughness of a binder coating film, and cycle characteristics of a secondary battery including a secondary battery negative electrode containing a silicon-based active material. The present invention also provides a composition for a secondary battery negative electrode mixture layer containing the binder, and a secondary battery negative electrode and a secondary battery obtained using the composition. An electrode binder for a secondary battery including a secondary battery negative electrode containing a silicon-based active material, the binder including a carboxyl group-containing polymer or a salt thereof (hereinafter, referred to as “polymer (A)”) and a hydroxyl group-containing polymer (different from the polymer (A), hereinafter, referred to as “polymer (B)”) optionally having a carboxyl group or a salt thereof.

### TECHNICAL FIELD

The present invention relates to an electrode binder for a secondary battery negative electrode containing a silicon-based active material, and use of the same.

### BACKGROUND ART

As a secondary battery, various power storage devices such as a nickel-hydrogen secondary battery, a lithium ion secondary battery, and an electric double layer capacitor have been put into practical use. Electrodes used in these secondary batteries are prepared by, for example, applying and drying a composition for forming an electrode mixture layer containing an active material, a binder, and the like onto a current collector. For example, in the lithium ion secondary battery, an aqueous binder containing styrene-butadiene rubber (SBR) latex and carboxymethylcellulose (CMC) is used as a binder used in a composition for a negative electrode mixture layer. On the other hand, an N-methyl-2-pyrrolidone (NMP) solution of polyvinylidene fluoride (PVDF) is widely used as a binder used for a positive electrode mixture layer.

In recent years, as applications of various secondary batteries expand, demands for improvement in energy density, reliability, and durability tend to increase. For example, specifications using a silicon-based active material as an active material for a negative electrode have been increasing for the purpose of increasing electric capacity of the lithium ion secondary battery. However, it is known that the silicon-based active material has a large volume change during charging and discharging, and there has been a problem that peeling, falling off, or the like of the electrode mixture layer occurs as the silicon-based active material is repeatedly used, and as a result, the capacity of the battery decreases, and cycle characteristics (durability) deteriorate.

In order to suppress such a problem, studies have been made to improve the durability by firmly binding active materials with a binder (binding property), reducing the size of the active material to alleviate stress associated with swelling and shrinkage, or devising an additive of an electrolytic solution.

Under such circumstances, it has been reported that an acrylic acid-based polymer is effective as a binder having good cycle characteristics and having an effect of improving durability of the negative electrode mixture layer using the silicon-based active material.

Patent Literature 1 discloses a binder containing a crosslinked acrylic acid-based polymer obtained by crosslinking polyacrylic acid with a specific crosslinking agent, and discloses that even when an active material containing the silicon-based active material is used, the binder exhibits good cycle characteristics without breaking an electrode structure. Although the binder disclosed in Patent Literature 1 can impart good cycle characteristics, there is a tendency to increase a ratio of the silicon-based active material in order to improve performance of the secondary battery, and there is a demand for a binder capable of obtaining higher cycle characteristics.

As a binder for secondary battery electrodes capable of improving the cycle characteristics of the secondary battery, for example. Patent Literature 2 discloses a binder for nonaqueous electrolyte secondary battery electrodes containing a copolymer of vinyl alcohol and an ethylenically unsaturated carboxylic acid alkali metal neutralized product, and at least one of poly(meth)acrylic acid and a poly(meth)acrylic acid alkali metal neutralized product, and Examples specifically describe that the binder exhibits good binding force to artificial graphite which is a negative electrode active material.

### CITATION LIST

### Patent Literature

Patent Literature 1: WO 2014/065407 A

Patent Literature 2: WO 2019/065704 A

### SUMMARY OF INVENTION

### Problems to be Solved by Invention

However, Patent Literature 2 does not specifically describe at all battery characteristics of a secondary battery including a secondary battery negative electrode containing a silicon-based active material with a volume change of 2 to 4 times during charging and discharging, and does not describe effectiveness in a system containing the silicon-based active material in a high concentration in the active material.

The present invention has been made in view of such circumstances, and an object of the present invention is to provide an electrode binder capable of improving toughness of a binder coating film, and cycle characteristics of a secondary battery including a secondary battery negative electrode containing a silicon-based active material. In addition, another object of the present invention is to provide a composition for a secondary battery negative electrode mixture layer containing the binder, and a secondary battery negative electrode and a secondary battery obtained using the composition.

### Solution to Problems

As a result of intensive studies to solve the above problems, the present inventors have found that by using an electrode binder containing a carboxyl group-containing polymer or a salt thereof and a hydroxyl group-containing polymer optionally having a carboxyl group different from that of the polymer, the toughness of the binder coating film and the cycle characteristics of the secondary battery including the secondary battery negative electrode containing the silicon-based active material are more excellent, and have completed the present invention.

The present invention is as follows.

[1] A binder for an electrode of a secondary battery including a secondary battery negative electrode containing a silicon-based active material, the binder including a carboxyl group-containing polymer or a salt thereof (hereinafter, referred to as “polymer (A)”) and a hydroxyl group-containing polymer (different from the “polymer (A)”, hereinafter, referred to as “polymer (B)”) optionally having a carboxyl group or a salt thereof.

[2] The electrode binder according to [1], in which an Rc value calculated by a formula (1) below based on the number of moles (hereinafter, referred to as “m_{A}”) of carboxyl groups of the polymer (A) and the number of moles (hereinafter, referred to as “m_{B}”) of hydroxyl groups of the polymer (B) is 0.1 or more and 0.9 or less.

$$Rc value = {m}_{A} / ( {m}_{A} + {m}_{B} ) \qquad ( 1 )$$

[3] The electrode binder according to [1] or [2]. in which the polymer (A) contains a structural unit derived from an ethylenically unsaturated carboxylic acid monomer in an amount of 40 mass % or more and 100 mass % or less with respect to all structural units of the polymer (A).

[4] The electrode binder according to any one of [1] to [3], in which the polymer (B) has a structural unit derived from vinyl alcohol.

[5] The electrode binder according to any one of [1] to [4], in which the polymer (B) has a carboxyl group or a salt thereof, and a molar ratio of the carboxyl group to the hydroxyl group is 5/95 or less.

[6] An electrode binder, wherein a tensile product of a binder coating film obtained from the electrode binder according to any one of [1] to [S] is 50 or more as a value calculated by a formula (2) below.

$$Tensile product ( MPa \cdot \% ) = maximum stress ( MPa ) \times elongation at break ( \% ) \qquad ( 2 )$$

[7] The electrode binder according to any one of [1] to [6], in which a content of the silicon-based active material is 30 mass % or more with respect to a total amount of the active material.

[8] A composition for a secondary battery negative electrode mixture layer, the composition containing the electrode binder according to any one of [1] to [7], a silicon-based active material, and water.

[9] A secondary battery negative electrode including a mixture layer formed of the composition for the secondary battery negative electrode mixture layer according to [8] on a surface of a current collector.

A secondary battery including the secondary battery negative electrode according to [9].

### Effects of Invention

According to the electrode binder of the present invention, it is possible to improve the toughness of the binder coating film, and the cycle characteristics of the secondary battery including the secondary battery negative electrode containing the silicon-based active material.

This is considered to be because in the case of a binder containing only the polymer (A), mechanical physical properties of the coating film is brittle due to strong hydrogen bonding between the carboxyl groups contained in the polymer (A), whereas in the case of a binder containing the polymer (B) in combination, the carboxyl group and the hydroxyl group form a hydrogen bond, and a hydrogen bond between the carboxyl groups of the polymer (A) is relaxed, and thus the toughness of the binder coating film is obtained.

### DESCRIPTION OF EMBODIMENTS

The electrode binder (hereinafter, also referred to as the “present binder”) of the present invention contains the polymer (A) and the polymer (B), and can be mixed with a silicon-based active material and water to form a composition for a secondary battery negative electrode mixture layer (hereinafter, also referred to as the “present composition”). The above composition is preferably an electrode slurry in a slurry state capable of being applied to a current collector from the viewpoint of exerting an effect of the present invention, but may be prepared in a wet powder state so as to be able to cope with press working on a surface of the current collector. By forming the mixture layer formed of the above composition on the surface of the current collector such as a copper foil, the secondary battery negative electrode of the present invention is obtained.

Hereinafter, each of the polymer (A), the polymer (B), the present binder, the composition for the secondary battery negative electrode mixture layer, a secondary battery electrode, and a secondary battery, which are obtained using the present binder will be described in detail.

Note that in the present specification, “(meth)acryl” means acryl and/or methacryl, and “(meth)acrylate” means acrylate and/or methacrylate. Further, “(meth)acryloyl group” means acryloyl group and/or methacryloyl group.

In numerical ranges described in stages in the present specification, an upper limit value or a lower limit value described in one numerical range may be replaced with an upper limit value or a lower limit value of a numerical range described in other stages, and the upper limit value or the lower limit value of the numerical range may be replaced with a value shown in Examples.

### 1. Polymer (A)

The polymer (A) has a structural unit (hereinafter, also referred to as “component (a)”) derived from an ethylenically unsaturated carboxylic acid monomer, and can be introduced into a polymer by performing known polymerization (solution polymerization, precipitation polymerization, suspension polymerization, emulsion polymerization, and the like) of a monomer component containing the component (a).

Further, the polymer (A) may be a crosslinked polymer or a non-crosslinked polymer. The crosslinked polymer and the non-crosslinked polymer may be used alone or in combination. Further, the crosslinked polymer or the non-crosslinked polymer may be used alone or in combination of two or more thereof.

### Structural Unit Derived from Ethylenically Unsaturated Carboxylic Acid Monomer

When the present polymer (A) has a carboxyl group by having a structural unit derived from the component (a), adhesiveness to the current collector is improved, and a lithium ion desolvation effect and ion conductivity are excellent, so that an electrode having low resistance and excellent high rate characteristics can be obtained. In addition, since water swellability is imparted, dispersion stability of the silicon-based active material and the like in the present composition can be improved.

Examples of the component (a) include: (meth)acrylic acid, itaconic acid, crotonic acid, maleic acid, fumaric acid; (meth)acrylamidoalkyl carboxylic acid such as (meth)acrylamidohexanoic acid and (meth)acrylamidododecanoic acid; and carboxyl group-containing ethylenically unsaturated monomers such as succinic acid monohydroxyethyl (meth)acrylate, ω-carboxy-caprolactone mono(meth)acrylate, and β-carboxyethyl (meth)acrylate, or (partially) alkali-neutralized products thereof, and one of them may be used alone, or two or more thereof may be used in combination. Among the above, from the viewpoint that a polymer having a long primary chain length is obtained due to a high polymerization rate and binding force of the binder is improved, a compound having an acryloyl group as a polymerizable functional group is preferable, and acrylic acid is particularly preferable. When acrylic acid is used as the ethylenically unsaturated carboxylic acid monomer, a polymer having a high carboxyl group content can be obtained.

The content of the component (a) in the polymer (A) is not particularly limited. but is preferably 40 mass % or more and 100 mass % or less with respect to all structural units of the polymer (A). When the component (a) is contained within such a range, the secondary battery negative electrode mixture layer can be made tough. The lower limit may be, for example, 50.0 mass % or more, for example, 60.0 mass % or more, or for example, 70.0 mass % or more. Further, the upper limit is, for example, 96.0 mass % or less, for example, 90.0 mass % or less, for example, 80.0 mass % or less, or for example, 70.0 mass % or less.

### Other Structural Units

The polymer (A) can contain a structural unit derived from another ethylenically unsaturated monomer copolymerizable with the component (a) (hereinafter, also referred to as “component (b)”) in addition to the component (a). Examples of the component (b) include a structural unit derived from a hydroxyl group-containing ethylenically unsaturated monomer (a monomer represented by the following formula (1) and a monomer represented by the following formula (2)), an ethylenically unsaturated monomer compound having an anionic group other than carboxyl groups, such as a sulfonic acid group and a phosphoric acid group, a nonionic ethylenically unsaturated monomer, or the like. These structural units can be introduced by copolymerizing an ethylenically unsaturated monomer compound having an anionic group other than carboxyl groups, such as a sulfonic acid group and a phosphoric acid group, or a monomer containing a nonionic ethylenically unsaturated monomer.

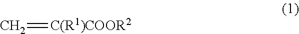

[In the formula, R¹ represents a hydrogen atom or a methyl group, R² represents a monovalent organic group having a hydroxyl group and 1 to 8 carbon atoms, (R³O)ₘH or R⁴O[CO(CH₂)₅O]ₙH. Note that R³ represents an alkylene group having 2 to 4 carbon atoms, R⁴ represents an alkylene group having 1 to 8 carbon atoms, m represents an integer of 2 to 15, and n represents an integer of 1 to 15]

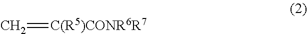

[In the formula, R⁵ represents a hydrogen atom or a methyl group, and R⁶ represents a hydroxyl group or a hydroxyalkyl group having 1 to 8 carbon atoms, and R⁷ represents a hydrogen atom or a monovalent organic group.]

However, the polymer (A) having a structural unit derived from the component (a) and a structural unit derived from the hydroxyl group-containing ethylenically unsaturated monomer polymer is different from the polymer (B) described later.

A ratio of the component (b) can be 0.1 mass % or more and 20 mass % or less with respect to all the structural units of the polymer (A). The ratio of the component (b) may be 0.5 mass % or more and 17.5 mass % or less, 1.0 mass % or more and 15 mass % or less, 2 mass % or more and 12.5 mass % or less, or 3 mass % or more and 10 mass % or less. In addition, when the component (b) is contained in an amount of 0.1 mass % or more with respect to all the structural units of the polymer (A), affinity to an electrolytic solution is improved, and thus an effect of improving lithium ion conductivity can also be expected.

As the component (b), among the components described above, the hydroxyl group-containing ethylenically unsaturated monomer is preferable from the viewpoint of excellent binding property of the binder containing salt of the polymer (A). In addition, a structural unit derived from a nonionic ethylenically unsaturated monomer is preferable from the viewpoint of obtaining an electrode having good bending resistance, and examples of the nonionic ethylenically unsaturated monomer include (meth)acrylamide and derivatives thereof, a nitrile group-containing ethylenically unsaturated monomer, and an alicyclic structure-containing ethylenically unsaturated monomer.

The monomer represented by the formula (1) is a (meth)acrylate compound having a hydroxyl group. When R² is a monovalent organic group having a hydroxyl group and 1 to 8 carbon atoms, the number of hydroxyl groups may be only 1 or 2 or more. The monovalent organic group is not particularly limited, and examples thereof include an alkyl group optionally having a linear, branched or cyclic structure, and an aryl group and an alkoxyalkyl group. Further, when R² is (R³O)ₘH or R⁴O[CO(CH₂)₅O]ₙH, the alkylene group represented by R³ or R⁴ may be linear or branched.

Examples of the monomer represented by the formula (1) include: hydroxyalkyl (meth)acrylates having a hydroxyalkyl group having 1 to 8 carbon atoms, such as 2-hydroxyethyl (meth)acrylate, 3-hydroxypropyl (meth)acrylate, 4-hydroxybutyl (meth)acrylate, hydroxyhexyl (meth)acrylate, and hydroxyoctyl (meth)acrylate; polyalkylene glycol mono(meth)acrylates such as polyethylene glycol mon (meth)acrylate, polypropylene glycol mono(meth)acrylate, polybutylene glycol mono(meth)acrylate, and polyethylene glycol-polypropylene glycol mono(meth)acrylate; dihydroxyalkyl (meth)acrylate such as glycerin mono(meth)acrylate; caprolactone-modified hydroxymethacrylate (trade names “Placcel FM1”, “Placcel FM5”, and the like manufactured by Daicel Corporation); and caprolactone-modified hydroxyacrylate (trade names “Placcel FA1”, “Placcel FA10L”, and the like manufactured by Daicel Corporation). The monomer represented by the formula (1) may be used alone or in combination of two or more thereof.

The monomer represented by the formula (2) is a (meth)acrylamide derivative having a hydroxyl group or a hydroxyalkyl group having 1 to 8 carbon atoms. In the formula (2), R⁷ represents a hydrogen atom or a monovalent organic group. The monovalent organic group is not particularly limited, and examples thereof include an alkyl group optionally having a linear, branched or cyclic structure, an aryl group, and an alkoxyalkyl group, and an organic group having 1 to 8 carbon atoms is preferable. In addition, R⁷ may be a hydroxyl group or a hydroxyalkyl group having 1 to 8 carbon atoms.

Examples of the monomer represented by the formula (2) include: hydroxy (meth)acrylamide; (meth)acrylamide derivatives having a hydroxyalkyl group having 1 to 8 carbon atoms, such as N-hydroxyethyl (meth)acrylamide. N-hydroxypropyl (meth)acrylamide, N-hydroxybutyl (meth)acrylamide. N-hydroxyhexyl (meth)acrylamide, and N-hydroxyoctyl (meth)acrylamide, N-methylhydroxyethyl (meth)acrylamide, and N-ethylhydroxyethyl (meth)acrylamide; and N,N-di-hydroxyalkyl (meth)acrylamide such as N,N-dihydroxyethyl (meth)acrylamide and N,N-dihydroxyethyl (meth)acrylamide. The monomer represented by the formula (2) may be used alone or in combination of two or more thereof.

Examples of the (meth)acrylamide derivative include: N-alkyl (meth)acrylamide compounds such as N-isopropyl (meth)acrylamide and N-t-butyl (meth)acrylamide; N-alkoxyalkyl (meth)acrylamide compounds such as N-n-butoxymethyl (meth)acrylamide and N-isobutoxymethyl (meth)acrylamide; and N,N-dialkyl (meth)acrylamide compounds such as N.N-dimethyl (meth)acrylamide and N,N-diethyl (meth)acrylamide, and one of them may be used alone, or two or more thereof may be used in combination.

Examples of the nitrile group-containing ethylenically unsaturated monomer include: (meth)acrylonitrile; cyanoalkyl (meth)acrylate ester compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide, and one of them may be used alone, or two or more thereof may be used in combination. Among the above, acrylonitrile is preferable from the viewpoint of having a large nitrile group content.

Examples of the alicyclic structure-containing ethylenically unsaturated monomer include: (meth)acrylic acid cycloalkyl esters optionally having an aliphatic substituent such as cyclopentyl (meth)acrylate, cyclohexyl (meth)acrylate, methylcyclohexyl (meth)acrylate, t-butylcyclohexyl (meth)acrylate, cyclodecyl (meth)acrylate, and cyclododecyl (meth)acrylate; isobomyl (meth)acrylate; adamantyl (meth)acrylate; cyclopentenyl (meth)acrylate; dicyclopentenyloxyethyl (meth)acrylate; dicyclopentanyl (meth)acrylate; and cycloalkyl polyalcohol mono(meth)acrylates such as cyclohexanedimethanol mono(meth)acrylate and cyclodecanedimethanol mono(meth)acrylate, and one of them may be used alone, or two or more thereof may be used in combination.

The polymer (A) preferably contains a structural unit derived from the monomer represented by the formula (1), the monomer represented by the formula (2), (meth)acrylamide and derivatives thereof, the nitrile group-containing ethylenically unsaturated monomer, the alicyclic structure-containing ethylenically unsaturated monomer, and the like from the viewpoint of excellent binding property of the binder.

As the component (b), from the viewpoint of excellent effect of improving the binding property of the present binder, hydroxyalkyl (meth)acrylate having a hydroxyalkyl group having 1 to 8 carbon atoms is more preferable, and 2-hydroxyethyl (meth)acrylate, 3-hydroxypropyl (meth)acrylate, and 4-hydroxybutyl (meth)acrylate are still more preferable.

In addition, as the component (b), when a structural unit derived from a hydrophobic ethylenically unsaturated monomer having solubility in water of 1 g/100 ml or less is introduced, a strong interaction with an electrode material can be obtained, and good binding property to the silicon-based active material can be exhibited. Thus, since a rigid and well-integrated negative electrode mixture layer can be obtained, the “hydrophobic ethylenically unsaturated monomer having solubility in water of 1 g/100 ml or less” described above is particularly preferably the alicyclic structure-containing ethylenically unsaturated monomer.

Further, as other nonionic ethylenically unsaturated monomers, for example, (meth)acrylic acid ester may be used. Examples of the (meth)acrylic acid ester include: (meth)acrylic acid alkyl ester compounds such as methyl (meth)acrylate, ethyl (meth)acrylate, n-butyl (meth)acrylate, isobutyl (meth)acrylate, and 2-ethylhexyl (meth)acrylate; aromatic (meth)acrylic acid ester compounds such as phenyl (meth)acrylate, phenylmethyl (meth)acrylate, phenylethyl (meth)acrylate, and phenoxyethyl (meth)acrylate; and (meth)acrylic acid alkoxyalkyl ester compounds such as 2-methoxyethyl (meth)acrylate and 2-ethoxyethyl (meth)acrylate, and one of them may be used alone, or two or more thereof may be used in combination.

From the viewpoint of the binding property with the silicon-based active material and the cycle characteristics, an aromatic (meth)acrylic acid ester compound can be preferably used. From the viewpoint of further improving the lithium ion conductivity and high rate characteristics, compounds having an ether bond, such as (meth)acrylic acid alkoxyalkyl ester such as 2-methoxyethyl (meth)acrylate and 2-ethoxyethyl (meth)acrylate are preferable, and 2-methoxyethyl (meth)acrylate is more preferable.

Among the nonionic ethylenically unsaturated monomers, the compound having an acryloyl group is preferable from the viewpoint that a polymer having a long primary chain length is obtained due to a high polymerization rate and the binding force of the binder is improved. In addition, as the nonionic ethylenically unsaturated monomer, a compound having a glass transition temperature (Tg) of a homopolymer of 0° C. or lower is preferable from the viewpoint that the bending resistance of the resulting electrode is improved.

The salt of the polymer (A) is in the form of a salt in which some or all of the carboxyl groups contained in the polymer are neutralized. The type of salt is not particularly limited, and examples of the salt include: alkali metal salts such as a lithium salt, a sodium salt, and a potassium salt; alkaline earth metal salts such as a magnesium salt, a calcium salt, and a barium salt; other metal salts such as an aluminum salt; ammonium salts; and organic amine salts. Among them, from the viewpoint that adverse effects on battery characteristics are less likely to occur, alkali metal salts and alkaline earth metal salts are preferable, and alkali metal salts are more preferable.

### 1.1. When Polymer (A) is Crosslinked Polymer

The polymer (A) may be a polymer having a crosslinked structure (the present crosslinked polymer), and a crosslinking method in the present crosslinked polymer is not particularly limited, and for example, aspects by the following methods are exemplified.

1) Copolymerization of Crosslinkable Monomers (However, Different from the Polyfunctional Crosslinking Agent)
2) Utilization of Chain Transfer to Polymer Chain During Radical Polymerization Since the present crosslinked polymer has a crosslinked structure, the binder containing the present crosslinked polymer salt can have an excellent binding force. Among the above methods, a method by copolymerization of a crosslinkable monomer is preferable from the viewpoint of easy operation and easy control of the degree of crosslinking.

### Crosslinkable Monomer

Examples of the crosslinkable monomer include a polyfunctional polymerizable monomer having two or more polymerizable unsaturated groups, and a monomer having a self-crosslinkable crosslinkable functional group such as a hydrolyzable silyl group.

The polyfunctional polymerizable monomer is a compound having two or more polymerizable functional groups such as a (meth)acryloyl group and an alkenyl group in the molecule, and examples thereof include a polyfunctional (meth)acryloyl compound, a polyfunctional alkenyl compound, and a compound having both a (meth)acryloyl group and an alkenyl group. Only one of these compounds may be used alone, or two or more thereof may be used in combination. Among them, from the viewpoint of easily obtaining a uniform crosslinked structure, the polyfunctional alkenyl compound is preferable and a polyfunctional allyl ether compound having two or more allyl ether groups in the molecule is particularly preferable.

Examples of the polyfunctional (meth)acryloyl compound include: di(meth)acrylates of dihydric alcohols such as ethylene glycol di(meth)acrylate, propylene glycol di(meth)acrylate, 1,6-hexanediol di(meth)acrylate, polyethylene glycol di(meth)acrylate, and polypropylene glycol di(meth)acrylate; poly(meth)acrylates such as tri(meth)acrylates or tetra(meth)acrylates of trihydric or higher polyhydric alcohol such as trimethylolpropane tri(meth)acrylate, tri(meth)acrylate of trimethylolpropane ethylene oxide modified product, glycerin tri(meth)acrylate, pentaerythritol tri(meth)acrylate, and pentaerythritol tetra(meth)acrylate; and bisamides such as methylene bisacrylamide and hydroxyethylene bisacrylamide.

Examples of the polyfunctional alkenyl compound include: polyfunctional allyl ether compounds such as trimethylolpropane diallyl ether, trimethylolpropane triallyl ether, pentaerythritol diallyl ether, pentaerythritol triallyl ether, tetraallyloxyethane, and polyallylsaccharose; polyfunctional allyl compounds such as diallyl phthalate; and polyfunctional vinyl compounds such as divinylbenzene.

Examples of the compound having both a (meth)acryloyl group and an alkenyl group include allyl (meth)acrylate, isopropenyl (meth)acrylate, butenyl (meth)acrylate, pentenyl (meth)acrylate, and 2-(2-vinyloxyethoxy)ethyl (meth)acrylate.

Specific examples of the monomer having a crosslinkable functional group capable of self-crosslinking include a hydrolyzable silyl group-containing vinyl monomer and N-methoxyalkyl (meth)acrylamide. One of these compounds can be used alone, or two or more thereof may be used in combination.

The hydrolyzable silyl group-containing vinyl monomer is not particularly limited as long as it is a vinyl monomer having at least one hydrolyzable silyl group. Examples of the hydrolyzable silyl group-containing vinyl monomer include: vinylsilanes such as vinyltrimethoxysilane, vinyltriethoxysilane, vinylmethyldimethoxysilane, and vinyldimethylmethoxysilane; silyl group-containing acrylic acid esters such as trimethoxysilylpropyl acrylate, triethoxysilylpropyl acrylate, and methyldimethoxysilylpropyl acrylate; silyl group-containing methacrylic acid esters such as trimethoxysilylpropyl methacrylate, triethoxysilylpropyl methacrylate, methyldimethoxysilylpropyl methacrylate, and dimethylmethoxysilylpropyl methacrylate; silyl group-containing vinyl ethers such as trimethoxysilylpropyl vinyl ether; and silyl group-containing vinyl esters such as vinyl trimethoxysilylundecanoate.

When the present crosslinked polymer is crosslinked with the crosslinkable monomer, an amount of the crosslinkable monomer used is preferably 0.01 parts by mass or more and 5.0 parts by mass or less, more preferably 0.05 parts by mass or more and 3.0 parts by mass or less, still more preferably 0.1 parts by mass or more and 2.0 parts by mass or less, still more preferably 0.1 parts by mass or more and 1.7 parts by mass or less, and yet still more preferably 0.5 parts by mass or more and 1.5 parts by mass or less with respect to 100 parts by mass of a total amount of monomers (non-crosslinkable monomers) other than the crosslinkable monomer. When the amount of the crosslinkable monomer used is 0.01 parts by mass or more, it is preferable from the viewpoint of further improving the binding property and sedimentation stability of the electrode slurry. When the amount of the crosslinkable monomer used is 5.0 parts by mass or less, stability of the precipitation polymerization or dispersion polymerization tends to be improved.

For the same reason, the amount of the crosslinkable monomer used is preferably 0.001 to 2.5 mol %, more preferably 0.01 to 2.0 mol %, still more preferably 0.05 to 1.75 mol %, still more preferably 0.05 to 1.5 mol %, and yet still more preferably 0.1 to 1.0 mol % with respect to the total amount of monomers (non-crosslinkable monomers) other than the crosslinkable monomer.

### Properties of Present Crosslinked Polymer Salt

It is preferable that an acid group such as a carboxyl group derived from the ethylenically unsaturated carboxylic acid monomer is neutralized so that the degree of neutralization is 20 mol % or more in the present composition, and the present crosslinked polymer is used as a salt form. The degree of neutralization is more preferably 50 mol % or more, still more preferably 70 mol % or more, still more preferably 75 mol % or more, yet still more preferably 80 mol % or more, and particularly preferably 85 mol % or more. The upper limit value of the degree of neutralization is 100 mol %, and may be 98 mol % or 95 mol %. When the degree of neutralization is 20 mol % or more, it is preferable from the viewpoint that the water swellability is improved, and a dispersion stabilizing effect is easily obtained. In the present specification, the degree of neutralization can be calculated from charged amount values of a monomer having an acid group such as a carboxyl group and a neutralizing agent used for neutralization. Note that the degree of neutralization can be confirmed from an intensity ratio of a peak derived from C═O group of a carboxylic acid to a peak derived from C═O group of a carboxylate by performing IR measurement of powders after the crosslinked polymer salt is dried at 80° C. for 3 hours under reduced pressure conditions.

### Particle Diameter of Present Crosslinked Polymer Salt

In the present composition, it is preferable that the present crosslinked polymer salt is not present as a mass (secondary aggregate) having a large particle diameter and is well dispersed as water-swelling particles having an appropriate particle diameter because the binder containing the crosslinked polymer salt can exhibit good binding performance.

The present crosslinked polymer preferably has a particle diameter (water-swelling particle diameter) in a range of 0.1 μm or more and 10.0 μm or less in terms of a volume-based median diameter when the crosslinked polymer having a degree of neutralization based on carboxyl groups of the crosslinked polymer of 80 to 100 mol % is dispersed in water. The range of the particle diameter is more preferably 0.15 μm or more and 8.0 μm or less, still more preferably 0.20 μm or more and 6.0 μm or less, still more preferably 0.25 μm or more and 4.0 μm or less, and yet still more preferably 0.30 μm or more and 2.0 μm or less. When the particle diameter is in the range of 0.30 μm or more and 2.0 μm or less, the particles are uniformly present in the present composition in a suitable size, so that stability of the present composition is high and excellent binding property can be exhibited. When the particle diameter exceeds 10.0 μm, there is a possibility that the binding property is insufficient as described above. In addition, there is a possibility that coatability is insufficient from the viewpoint that a smooth coating surface is difficult to be obtained. On the other hand, when the particle diameter is less than 0.1 μm, there is a concern from the viewpoint of stable manufacturability.

### Method for Producing Present Crosslinked Polymer

The present crosslinked polymer is obtained by a method including a step of polymerizing a monomer component containing a monomer component containing an ethylenically unsaturated carboxylic acid monomer by precipitation polymerization or dispersion polymerization.

Here, the precipitation polymerization is a method for producing a polymer by performing a polymerization reaction in a solvent that dissolves a monomer that is a raw material but does not substantially dissolve a polymer to be produced. As the polymerization proceeds, polymer particles become larger due to aggregation and growth, and a dispersion liquid of the polymer particles in which primary particles of several tens nm to several hundreds nm are secondarily aggregated into several um to several tens um is obtained. Dispersion stabilizers can also be used to control a particle size of the polymer.

Note that the secondary aggregation can also be suppressed by selecting a dispersion stabilizer, a polymerization solvent, or the like. In general, the precipitation polymerization in which the secondary aggregation is suppressed is also called the dispersion polymerization.

In the case of the precipitation polymerization, a solvent selected from water, various organic solvents, and the like can be used as the polymerization solvent in consideration of the type of the monomer to be used and the like. In order to obtain a polymer having a longer primary chain length, it is preferable to use a solvent having a small chain transfer constant.

Specific examples of the polymerization solvent include, in addition to water-soluble solvents such as methanol, t-butyl alcohol, acetone, methyl ethyl ketone, acetonitrile, and tetrahydrofuran, benzene, ethyl acetate, dichloroethane, n-hexane, cyclohexane, and n-heptane, and these can be used alone or in combination of two or more. Alternatively, it may be used as a mixed solvent of these and water. In the present invention, the water-soluble solvent refers to a solvent having a solubility in water at 20° C. of more than 10 g/100 ml.

Among the above, methyl ethyl ketone and acetonitrile are preferable from the viewpoints that generation of coarse particles and adhesion to a reactor are small and polymerization stability is good, precipitated polymer fine particles are hardly secondarily aggregated (or dissolve easily in water medium even if secondary aggregation occurs), a polymer having a small chain transfer constant and a large degree of polymerization (a long primary chain length) is obtained, and the operation is easy during neutralization in the process described later.

As a polymerization initiator, a known polymerization initiator such as an azo-based compound, an organic peroxide, or an inorganic peroxide can be used, but the polymerization initiator is not particularly limited. The use conditions can be adjusted so as to obtain an appropriate amount of radical generation by a known method such as thermal initiation, redox initiation using a reducing agent in combination, or UV initiation. In order to obtain a crosslinked polymer having a long primary chain length, it is preferable to set conditions such that the amount of radical generation is further reduced within a range of allowable production time.

An amount of the polymerization initiator used is preferably, for example, 0.001 to 2 parts by mass, for example, 0.005 to 1 part by mass, or for example, 0.01 to 0.1 parts by mass when the total amount of the monomer components used is 100 parts by mass. When the amount of the polymerization initiator used is 0.001 parts by mass or more, the polymerization reaction can be stably performed, and when the amount of the polymerization initiator used is 2 parts by mass or less, it is easy to obtain the polymer having a long primary chain length.

The polymerization temperature is preferably 0 to 100° C., and more preferably 20 to 80° C. although it depends on conditions such as the type and concentration of the monomer to be used. The polymerization temperature may be constant or may change during the polymerization reaction. Further, the polymerization time is preferably 1 minute to 20 hours, and more preferably 1 hour to 10 hours.

### 1.2. When Polymer (A) is Non-Crosslinked Polymer

The polymer (A) may be a polymer (the present non-crosslinked polymer) having no crosslinked structure, and the present non-crosslinked polymer contains a structural unit (the component (a)) derived from the ethylenically unsaturated carboxylic acid monomer. A method for introducing the component (a) of the present non-crosslinked polymer may be the same as a method described in the component (a) of the present crosslinked polymer.

The content of the component (a) in the present non-crosslinked polymer is, in terms of solubility in water, 50 mass % or more and 100 mass % or less, preferably 60 mass % or more and 100 mass % or less, more preferably 70 mass % or more and 100 mass % or less, and still more preferably 80 mass % or more and 100 mass % or less with respect to all structural units of the present non-crosslinked polymer.

### Other Structural Units

The present non-crosslinked polymer can contain, in addition to the component (a), a structural unit (the component (b)) derived from another ethylenically unsaturated monomer copolymerizable therewith.

A method for introducing the component (b) may be the same as a method described in the component (b) of the present crosslinked polymer.

The ratio of the component (b) can be 0 mass % or more and 50 mass % or less with respect to all the structural units of the present non-crosslinked polymer. The ratio of the component (b) may be 1 mass % or more and 50 mass % or less, 2 mass % or more and 50 mass % or less, 5 mass % or more and 50 mass % or less, or 10 mass % or more and 50 mass % or less.

The present non-crosslinked polymer may be in the form of a salt in which some or all of the carboxyl groups contained in the polymer are neutralized. The type of the salt is not particularly limited, and examples of the salt include: salts of alkali metals such as lithium, sodium, and potassium; alkaline earth metal salts such as a magnesium salt, a calcium salt, and a barium salt; other metal salts such as an aluminum salt; ammonium salts; and organic amine salts. Among them, from the viewpoint that adverse effects on battery characteristics are less likely to occur, alkali metal salts and alkaline earth metal salts are preferable, and alkali metal salts are more preferable.

It is preferable that an acid group such as a carboxyl group derived from the ethylenically unsaturated carboxylic acid monomer is neutralized so that the degree of neutralization is 20 mol % or more in the present composition, and the present non-crosslinked polymer is used as a salt form. The degree of neutralization is more preferably 50 mol % or more, still more preferably 70 mol % or more, still more preferably 75 mol % or more, yet still more preferably 80 mol % or more, and particularly preferably 85 mol % or more. The upper limit value of the degree of neutralization is 100 mol %, and may be 98 mol % or 95 mol %. When the degree of neutralization is 20 mol % or more, it is preferable from the viewpoint that the solubility in water is easily secured. In the present specification, the degree of neutralization can be calculated from charged amount values of a monomer having an acid group such as a carboxyl group and a neutralizing agent used for neutralization. Note that the degree of neutralization can be confirmed from the intensity ratio of the peak derived from C═O group of the carboxylic acid to the peak derived from C═O group of the carboxylate by performing IR measurement of the powders after the crosslinked polymer or salt thereof is dried at 80° C. for 3 hours under reduced pressure conditions.

The weight average molecular weight (Mw) of the present non-crosslinked polymer is not particularly limited, and is preferably 5,000 or more, and more preferably 10,000 or more from the viewpoint of obtaining an electrode mixture layer excellent in binding property. Mw may be 100,000 or more, 500,000 or more, or 1,000,000 or more. The upper limit value of Mw is also not particularly limited, and may be, for example, 10,000,000 or less or 5,000,000 or less from the viewpoint of handling in production.

### Method for Producing Present Non-Crosslinked Polymer

As a method for producing the present non-crosslinked polymer, a known polymerization method (solution polymerization, precipitation polymerization, suspension polymerization, emulsion polymerization, and the like) can be used, and the method may be appropriately selected depending on the molecular weight, composition, or the like.

As a polymerization initiator, a known polymerization initiator such as an azo-based compound, an organic peroxide, or an inorganic peroxide can be used, but the polymerization initiator is not particularly limited. The use conditions can be adjusted so as to obtain an appropriate amount of radical generation by a known method such as thermal initiation, redox initiation using a reducing agent in combination, or UV initiation.

In addition, for the purpose of, for example, adjusting the molecular weight, a known chain transfer agent may be used as necessary.

### 2. Polymer (B)

The polymer (B) is a hydroxyl group-containing polymer (however, it is different from the polymer (A)) optionally having a carboxyl group or a salt thereof, and is not particularly limited, and examples thereof include a polymer having a structural unit derived from the hydroxyl group-containing ethylenically unsaturated monomer and a polymer having a structural unit (hereinafter, also referred to as “component (c)”) derived from vinyl alcohol. As the polymer (B), a polymer having the component (c) is particularly preferable from the viewpoint that the present binder coating film is excellent in toughness and the cycle characteristics of the secondary battery including the secondary battery negative electrode containing the silicon-based active material can be improved.

Further, the polymer (B) may be a crosslinked polymer or a non-crosslinked polymer. The crosslinked polymer and the present non-crosslinked polymer may be used alone or in combination. Further, the crosslinked polymer or the non-crosslinked polymer may be used alone or in combination of two or more thereof.

### Structural Unit Derived from Vinyl Alcohol

An example of a method for introducing the component (c) is a method of saponifying a polymer obtained by polymerizing a monomer component containing a vinyl ester compound such as vinyl acetate or vinyl propionate using a known polymerization method (solution polymerization, precipitation polymerization, suspension polymerization, emulsion polymerization, and the like).

As the vinyl ester compound, vinyl acetate is preferable from the viewpoint of easy availability of a raw material, easy progress of a saponification reaction, and the like. The vinyl ester compound may be used alone or in combination of two or more thereof.

A ratio of the component (c) can be 5 mass % or more and 100 mass % or less with respect to all structural units of the polymer (B). The ratio of the component (c) may be 10 mass % or more and 100 mass % or less, 20 mass % or more and 100 mass % or less, 30 mass % or more and 100 mass % or less, 40 mass % or more and 100 mass % or less, or 50 mass % or more and 100 mass % or less.

### Other Structural Units

Furthermore, the polymer (B) may have a carboxyl group or a salt thereof, and examples of the method for introducing a carboxyl group or a salt thereof include a method of saponifying a polymer obtained by polymerizing a monomer component containing a vinyl ester compound such as vinyl acetate or vinyl propionate and an ethylenically unsaturated carboxylic acid ester compound such as a (meth)acrylic acid alkyl ester compound using known polymerization described above.

Examples of the vinyl ester compound include vinyl acetate and vinyl propionate in the same manner as described above, and vinyl acetate is preferable from the viewpoint of easy availability of the raw material, easy progress of the saponification reaction, and the like.

Examples of the (meth)acrylic acid alkyl ester compound include methyl (meth)acrylate, ethyl (meth)acrylate, n-propyl (meth)acrylate, isopropyl (meth)acrylate, n-butyl (meth)acrylate, and t-butyl (meth)acrylate, and methyl acrylate and methyl methacrylate are preferable from the viewpoint of easy progress of the saponification reaction.

Here, when the polymer (B) has a carboxyl group or a salt thereof, the molar ratio of the carboxyl group to the hydroxyl group is preferably 5/95 or less, more preferably 4/96 or less, still more preferably 3/97 or less, still more preferably 2/98 or less, and yet still more preferably 1/99 or less from the viewpoint that the cycle characteristics of the secondary battery including the secondary battery negative electrode containing the silicon-based active material can be improved.

In this case, it is considered that concentration of carboxyl group of the polymer (B) is low, and after coating and drying of the composition, an intermolecular interaction between the carboxyl group and the hydroxyl group of other molecules is dominant as compared with a pseudo cyclic crosslinked structure in the molecule due to an interaction between the carboxyl group and the hydroxyl group in the same molecule, and thus the binder coating film is toughened to improve the cycle characteristics of the secondary battery including the secondary battery negative electrode containing the silicon-based active material.

### Method for Producing Polymer (B)

As a method for producing the polymer (B), a known polymerization method (solution polymerization, precipitation polymerization, suspension polymerization, emulsion polymerization, and the like) can be used, and the method may be appropriately selected depending on the molecular weight, composition, or the like.

As a polymerization initiator, a known polymerization initiator such as an azo-based compound, an organic peroxide, or an inorganic peroxide can be used, but the polymerization initiator is not particularly limited. The use conditions can be adjusted so as to obtain an appropriate amount of radical generation by a known method such as thermal initiation, redox initiation using a reducing agent in combination, or UV initiation.

In addition, for the purpose of, for example, adjusting the molecular weight, a known chain transfer agent may be used as necessary.

When the polymer (B) has a carboxyl group, the polymer (B) may be in the form of a salt in which some or all of the carboxyl groups are neutralized. The type of the salt is not particularly limited, and examples of the salt include: salts of alkali metals such as lithium, sodium, and potassium; alkaline earth metal salts such as a magnesium salt, a calcium salt, and a barium salt; other metal salts such as an aluminum salt; ammonium salts; and organic amine salts. Among them, from the viewpoint that adverse effects on battery characteristics are less likely to occur, alkali metal salts and alkaline earth metal salts are preferable, and alkali metal salts are more preferable.

### 3. Present Binder

The present binder contains the polymer (A) and the polymer (B).

As amounts of the polymer (A) and the polymer (B) used, from the viewpoint that the toughness of the binder coating film and the cycle characteristics of the secondary battery including the secondary battery negative electrode containing the silicon-based active material can be improved, an Rc value calculated by the following formula (1) based on the number of moles (m_{A}) of carboxyl groups of the polymer (A) and the number of moles (m_{B}) of hydroxyl groups of the polymer (B) is preferably 0.1 or more and 0.9 or less, more preferably 0.2 or more and 0.8 or less, still more preferably 0.3 or more and 0.7 or less, and yet still more preferably 0.4 or more and 0.7 or less.

$$Rc value = {m}_{A} / ( {m}_{A} + {m}_{B} ) \qquad ( 1 )$$

In addition, a tensile product of the binder coating film obtained from the present binder is preferably 50 or more, more preferably 100 or more, still more preferably 300 or more, still more preferably 800 or more, and yet still more preferably 1,000 or more as a value calculated by the following formula (2) from the viewpoint that the cycle characteristics of the secondary battery including the secondary battery negative electrode containing the silicon-based active material can be improved. Note that the upper limit value is not particularly limited, but the maximum value is 100,000 MPa.

$$Tensile product ( MPa \cdot \% ) = maximum stress ( MPa ) \times elongation at break ( \% ) \qquad ( 2 )$$

### 4. Composition for Secondary Battery Negative Electrode Mixture Layer

The composition for the secondary battery negative electrode mixture layer of the present invention contains the present binder, the silicon-based active material, and water.

An amount of the present binder used in the present composition is, for example, 0.1 parts by mass or more and 20 parts by mass or less with respect to 100 parts by mass of a total amount of the silicon-based active material. The use amount is, for example, 0.2 parts by mass or more and 10 parts by mass or less, for example, 0.3 parts by mass or more and 8 parts by mass or less, or for example, 0.4 parts by mass or more and 5 parts by mass or less. When the amount of the binder used is 0.1 parts by mass or more, sufficient binding property can be obtained. In addition, the dispersion stability of the silicon-based active material and the like can be secured, and a uniform mixture layer can be formed. When the amount of the binder used is 20 parts by mass or less, the present composition does not have a high viscosity, and the coatability to the current collector can be secured. As a result, a mixture layer having a uniform and smooth surface can be formed.

As the silicon-based active material, an active material including a silicon-based material such as silicon, a silicon alloy, and silicon oxide such as silicon monoxide (SiO) can be used. The amount of the silicon-based active material used is preferably 30 mass % or more, more preferably 35 mass % or more, still more preferably 40 mass % or more, still more preferably 45 mass % or more, and yet still more preferably 50 mass % or more of a total amount of the active material from the viewpoint of increasing electric capacity of the lithium ion secondary battery.

As the negative electrode active material, a carbon-based material, a lithium metal, a lithium alloy, a metal oxide, and the like may be contained in addition to the silicon-based active material, and one or two or more thereof can be used in combination. Among them, active materials (hereinafter, also referred to as “carbon-based active material”) including carbon-based materials such as natural graphite, artificial graphite, hard carbon, and soft carbon are preferable, and graphites such as natural graphite and artificial graphite, and hard carbon are more preferable. In addition, in the case of graphite, spheroidized graphite is suitably used from the viewpoint of battery performance, and a preferable range of the particle size is, for example, 1 to 20 μm, or for example, 5 to 15 μm. In addition, in order to increase the energy density, a metal, a metal oxide, or the like, capable of absorbing lithium, such as tin can be used as the negative electrode active material.

Since the carbon-based active material itself has good electrical conductivity, it is not always necessary to add a conductive auxiliary agent. When the conductive auxiliary agent is added for the purpose of further reducing the resistance, or the like, an amount of the carbon-based active material used is, for example, 10 parts by mass or less, or for example, 5 parts by mass or less, with respect to 100 parts by mass of the total amount of the active material from the viewpoint of the energy density.

When the present composition is in the slurry state, an amount of the active material used is, for example, in the range of 30 to 80 mass %, or for example, in the range of 40 to 70 mass %, with respect to a total amount of the present composition. When the amount of the active material used is 30 mass % or more, migration of the binder and the like is suppressed, and it is also advantageous in terms of drying cost of the medium. On the other hand, when the amount of the active material used is 80 mass % or less, fluidity and coatability of the present composition can be secured, and the uniform mixture layer can be formed.

The present composition uses water as the medium. In addition, for the purpose of adjusting properties, drying properties, and the like of the present composition, a mixed solvent with a water-soluble organic solvent such as lower alcohols such as methanol and ethanol, carbonates such as ethylene carbonate, ketones such as acetone, tetrahydrofuran, or N-methyl-2-pyrrolidone may be used. A ratio of water in a mixed medium is, for example, 50 mass % or more, or for example, 70 mass % or more.

When the present composition is brought into a coatable slurry state, the content of the medium containing water in the entire present composition can be, for example, in the range of 25 to 60 mass %, or for example, 35 to 60 mass %, from the viewpoint of coatability of the slurry, energy cost required for drying, and productivity.

The present composition may further contain other binder components such as styrene-butadiene rubber (SBR)-based latex, carboxymethylcellulose (CMC), acrylic latex, and polyvinylidene fluoride latex in combination. When another binder component is used in combination, the use amount can be, for example, 0.1 to 5 parts by mass or less, for example, 0.1 to 2 parts by mass or less, or for example, 0.1 to 1 part by mass or less with respect to 100 parts by mass of the total amount of the active material. When an amount of the other binder component used exceeds 5 parts by mass, the resistance may increase, and the high-rate characteristics may be insufficient. Among the above, from the viewpoint of excellent balance between the binding property and the bending resistance, SBR-based latex and CMC are preferable, and SBR-based latex and CMC are more preferably used in combination.

The SBR-based latex refers to an aqueous dispersion of a copolymer having a structural unit derived from an aromatic vinyl monomer such as styrene and a structural unit derived from an aliphatic conjugated diene-based monomer such as 1,3-butadiene. Examples of the aromatic vinyl monomer include o-methylstyrene, vinyltoluene, and divinylbenzene in addition to styrene, and one or two or more thereof can be used. The structural unit derived from the aromatic vinyl monomer in the copolymer can be, for example, in the range of 20 to 70 mass %, or for example, in the range of 30 to 60 mass %. mainly from the viewpoint of the binding property.

Examples of the aliphatic conjugated diene-based monomer include 2-methyl-1,3-butadiene, 2,3-dimethyl-1,3-butadiene, and 2-chloro-1,3-butadiene in addition to 1,3-butadiene, and one or two or more thereof can be used. The structural unit derived from the aliphatic conjugated diene-based monomer in the copolymer can be, for example, in the range of 30 to 70 mass %, or for example, in the range of 40 to 60 mass %, from the viewpoint that the binding property of the binder and flexibility of the resulting electrode are good.

Regarding the styrene-butadiene-based latex, in order to further improve performance such as the binding property, in addition to the above-described monomers, a nitrile group-containing monomer such as (meth)acrylonitrile, a carboxyl group-containing monomer such as (meth)acrylic acid, itaconic acid, or maleic acid, or an ester group-containing monomer such as methyl (meth)acrylate, as another monomer, may be used as a copolymer monomer.

The structural unit derived from the other monomer in the copolymer can be, for example, in the range of 0 to 30 mass %, or for example, in the range of 0 to 20 mass %.

The CMC refers to a substituted product obtained by substituting a nonionic cellulose-based semi-synthetic polymer compound with a carboxymethyl group, and a salt thereof. Examples of the nonionic cellulose-based semi-synthetic polymer compound include: alkyl celluloses such as methyl cellulose, methyl ethyl cellulose, ethyl cellulose, and microcrystalline cellulose; and hydroxyalkyl celluloses such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose.

The composition for the secondary battery negative electrode mixture layer of the present invention contains the binder, the silicon-based active material, and water as essential components, and is obtained by mixing the components using known means. A method for mixing the components is not particularly limited, and a known method can be adopted, but a method is preferable in which powder components such as the active material, the conductive auxiliary agent, and the binder are dry-blended, then mixed with a dispersion medium such as water, and dispersed and kneaded. When the present composition is obtained in the slurry state, it is preferable to finish the composition into a slurry having no poor dispersion or aggregation. As a mixing means, a known mixer such as a planetary mixer, a thin-film swirling mixer, or a rotation-revolution mixer can be used, but it is preferable to use the thin-film swirling mixer from the viewpoint that a good dispersion state can be obtained in a short time. In addition, in the case of using the thin-film swirling mixer, it is preferable to perform preliminary dispersion in advance with a stirrer such as a disperser. The pH of the slurry is not particularly limited as long as the effect of the present invention is obtained, but is preferably less than 12.5, and for example, in the case of blending the CMC, the pH is more preferably less than 11.5 and still more preferably less than 10.5 from the viewpoint that concern of hydrolysis of the CMC is small. Further, the viscosity of the slurry is not particularly limited as long as the effect of the present invention is obtained, but the B-type viscosity (25° C.) at 20 rpm can be, for example, in the range of 100 to 6,000 mPa·s, for example, in the range of 500 to 5,000 mPa·s, or for example, in the range of 1,000 to 4,000 mPa·s. When the viscosity of the slurry is within the above range, good coatability can be secured.

### 5. Secondary Battery Negative Electrode

The secondary battery negative electrode of the present invention includes a mixture layer formed of the composition for the secondary battery negative electrode mixture layer of the present invention on the surface of the current collector such as copper. The mixture layer is formed by applying the present composition to the surface of the current collector and then drying and removing the medium such as water. The method for applying the present composition is not particularly limited, and known methods such as a doctor blade method, a dip method, a roll coating method, a comma coating method, a curtain coating method, a gravure coating method, and an extrusion method can be employed. Further, the drying can be performed by a known method such as warm air blowing, decompression, (far) infrared ray irradiation, or microwave irradiation.

Usually, the mixture layer obtained after drying is subjected to compression treatment by a die press, a roll press, or the like. By compressing, the active material and the binder can be brought into close contact with each other, and strength of the mixture layer and adhesion to the current collector can be improved. A thickness of the mixture layer can be adjusted to, for example, about 30 to 80% of that before compression by compression, and the thickness of the mixture layer after the compression is generally about 4 to 200 μm.

### 6. Secondary battery

A secondary battery can be produced by providing the secondary battery negative electrode of the present invention with a secondary electrode positive electrode, a separator, and an electrolytic solution.

Here, as a positive electrode active material for the secondary electrode positive electrode, a lithium salt of a transition metal oxide can be used, and for example, layered rock salt-type and spinel-type lithium-containing metal oxides can be used. Examples of specific compounds of the layered rock salt-type positive electrode active material include lithium cobaltate, lithium nickelate, and NCM{Li(Niₓ, Co_{y}, Mn_{z}), x+y+z=1} and NCA {Li(Ni_{1-a-b}CoₐAl_{b})} which are called temary systems. Further, examples of the spinel-type positive electrode active material include lithium manganate. In addition to the oxides, phosphate, silicate, sulfur, and the like are used, and examples of the phosphate include olivine-type lithium iron phosphate. As the positive electrode active material, one of the above may be used alone, or two or more thereof may be used in combination as a mixture or a composite.

Note that when the positive electrode active material containing the layered rock salt-type lithium-containing metal oxide is dispersed in water, lithium ions on the surface of the active material and hydrogen ions in water are exchanged, and thus the dispersion liquid exhibits alkalinity. Therefore, there is a possibility that aluminum foil (Al) or the like which is a general current collector material for a positive electrode is corroded. In such a case, it is preferable to neutralize the alkali content eluted from the active material by using the unneutralized or partially neutralized present polymer as the binder. In addition, the amount of the present polymer which is not neutralized or partially neutralized is preferably used such that an amount of unneutralized carboxyl groups in the present polymer is equal to or more than an equivalent amount with respect to an amount of alkali eluted from the active material.

Since all of the positive electrode active materials have low electrical conductivity, the conductive auxiliary agent is generally added and used. Examples of the conductive auxiliary agent include carbon-based materials such as carbon black, carbon nanotube, carbon fiber, graphite fine powder, and carbon fiber, and among these, carbon black, carbon nanotube, and carbon fiber are preferable from the viewpoint of easily obtaining excellent conductivity. Further, as the carbon black, Ketjen black and acetylene black are preferable. As the conductive auxiliary agent, one of the above-described ones may be used alone, or two or more thereof may be used in combination. From the viewpoint of achieving both conductivity and energy density, an amount of the conductive auxiliary agent used can be, for example, 0.2 to 20 parts by mass, or for example, 0.2 to 10 parts by mass, with respect to 100 parts by mass of the total amount of the active material. Further, the positive electrode active material may be surface-coated with a conductive carbon-based material.

The electrolytic solution may be liquid or gel.

The separator is disposed between the positive electrode and the negative electrode of the battery, and plays a role of preventing a short circuit due to contact between both electrodes and holding the electrolytic solution to ensure ion conductivity. The separator is preferably a film-like insulating microporous membrane having good ion permeability and mechanical strength. As a specific material, polyolefins such as polyethylene and polypropylene, polytetrafluoroethylene, and the like can be used.

As the electrolytic solution, a generally used known electrolytic solution can be used depending on the type of the active material. In the lithium ion secondary battery, specific solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate, and diethyl carbonate, and these can be used alone or as a mixed solvent. The electrolytic solution is used by dissolving a lithium salt such as LiPF₆, LiSbF₆, LiBF₄, LiClO₄, or LiAlO₄ in these solvents. In a nickel-hydride secondary battery, a potassium hydroxide aqueous solution can be used as the electrolytic solution. The secondary battery is obtained by forming a positive electrode plate and a negative electrode plate separated by the separator into a spiral shape or a laminated structure and storing them in a case or the like.

The electrode binder disclosed in the present specification is excellent in toughness of the binder coating film, and a secondary battery including a secondary battery negative electrode obtained using the binder can ensure good integrity, and exhibits good durability (cycle characteristics) even when charging and discharging are repeated, and thus is suitable for vehicle-mounted secondary batteries and the like.

### EXAMPLES

Hereinafter, the present invention will be specifically described based on Examples. Note that the present invention is not limited to these Examples. Note that In the following description, “parts” and “%” respectively mean parts by mass and mass % unless otherwise specified.

### Production of Carboxyl Group-Containing Polymer Salt

### Production Example 1: Production of Carboxyl Group-Containing Crosslinked Polymer Salt P-1

For the polymerization, a reactor equipped with a stirring blade, a thermometer, a reflux condenser, and a nitrogen inlet tube was used.

A reactor was charged with 875.6 parts of acetonitrile. 4.40 parts of ion-exchanged water, 100 parts of acrylic acid, and 0.5 parts of pentaerythritol triallyl ether (trade name “NEOALLYL P-30” manufactured by Osaka Soda Co., Ltd.). An inside of the reactor was sufficiently purged with nitrogen, and then heated to raise an internal temperature to 55° C. After confirming that the internal temperature was stabilized at 55° C., 0.04 parts of 2,2′-azobis (2,4-dimethylvaleronitrile) (trade name “V-65” manufactured by FUJIFILM Wako Pure Chemical Corporation) was added as a polymerization initiator, and white turbidity was observed in a reaction solution, and thus this point was defined as a polymerization initiation point. The polymerization reaction was continued while maintaining the internal temperature at 55° C. by adjusting an external temperature (a water bath temperature), cooling of the reaction solution was started at a time point when 5 hours had elapsed from the polymerization initiation point, and after the internal temperature decreased to 25° C., 52.5 parts of a powder of lithium hydroxide monohydrate (hereinafter, referred to as “LiOH·H₂O”) was added. After the addition, stirring was continued at room temperature for 12 hours to obtain a slurry-like polymerization reaction solution in which particles of carboxyl group-containing crosslinked polymer salt P-1 (Li salt, degree of neutralization: 90 mol %) were dispersed in the medium.

The obtained polymerization reaction solution was centrifuged to precipitate the polymer, and then supernatant was removed. Thereafter, a washing operation in which the precipitate was redispersed in acetonitrile having the same weight as the polymerization reaction solution, and then polymer particles were precipitated by centrifugation to remove the supernatant was repeated twice. The precipitate was collected and dried at 80° C. for 3 hours under reduced pressure conditions to remove volatiles, thereby obtaining a powder of carboxyl group-containing crosslinked polymer salt P-1. Since the carboxyl group-containing crosslinked polymer salt P-1 had hygroscopicity, it was hermetically stored in a container having a water vapor barrier property. Note that when the powder of carboxyl group-containing crosslinked polymer salt R-I was subjected to IR measurement, and the degree of neutralization was determined from an intensity ratio of the peak derived from C═O group of the carboxylic acid to a peak derived from C═O of lithium carboxylate, the degree of neutralization was 90 mol % which was equal to a calculated value from the charged amount.

### Production of Hydroxyl Group-Containing Polymer

### Production Example 2: Production of Hydroxyl Group-Containing Polymer CP-1

For the polymerization, a reactor equipped with a stirring blade, a thermometer, a reflux condenser, and a nitrogen inlet tube was used.

A monomer solution was prepared by mixing 1 part of methyl acrylate (hereinafter, referred to as “MA”) and 19 parts of vinyl acetate (hereinafter, referred to as “VAc”), and dissolving 0.67 parts of 2,2′-azobis(isobutyric acid)dimethyl (trade name “V-601” manufactured by FUJIFILM Wako Pure Chemical Corporation).

A reactor was charged with 410 parts of water. 10 parts of anhydrous sodium sulfate, 1 part of partially saponified polyvinyl alcohol (manufactured by Kuraray Co., Ltd., trade name “PVA-217”, degree of saponification: 88%), and 20.67 parts of the monomer solution. The inside of the reactor was sufficiently purged with nitrogen, and then heated to raise the internal temperature to 60° C. After it was confirmed that the internal temperature was stabilized at 60° C., a mixed solution of 4 parts of MA and 76 parts of VAc was added dropwise with a dropping funnel over 4 hours, cooling of the reaction solution was started at a time point when I hour had elapsed from completion of dropping, and the reaction was terminated to obtain a polymerization reaction solution containing a copolymer of MA and VAc.

Here, amounts of residual monomers were measured by gas chromatography (GC) measurement, and polymerization ratios of the monomers were calculated, and then the polymerization ratios of the monomers were MA: 98% and VAc: 96%.

A part of the obtained polymerization reaction solution was dissolved in tetrahydrofuran and then filtered through a membrane filter (manufactured by ADVANTEC CO., LTD., pore size: 0.45 μm), and then the copolymer of MA and VAc was subjected to gel permeation chromatography (GPC) measurement under the following conditions to obtain a weight average molecular weight (Mw) in terms of polystyrene of 1.08 million.

### Measurement Conditions

Column: TSKgel SuperMultiporeHZ-M manufactured by Tosoh Corporation×4 columns
Solvent: tetrahydrofuran
Temperature: 40° C.
Detector: RI
Flow rate: 600 μL/min

The polymerization reaction solution containing the copolymer of MA and VAc was heated to the extemal temperature of 50° C., and then desolventized under reduced pressure conditions to remove the residual monomers. Thereafter, 500 parts of methanol and 38.8 parts of LiOH·H₂O were charged with respect to 100 parts of a total amount of the copolymerized monomers (MA and VAc) charged, and the saponification reaction was performed at the external temperature of 50° C. for 3 hours to obtain a reaction solution containing a saponified product of the copolymer of MA and VAc.

The reaction solution containing the saponified product was reprecipitated in acetone, filtered, and then dried at 80° C. for 12 hours to remove volatile components, thereby obtaining a saponified product of the copolymer of MA and VAc (hereinafter, also referred to as “hydroxyl group-containing polymer CP-1”). Here, based on the polymerization ratios of MA and VAc, the hydroxyl group-containing polymer CP-1 is a lithium salt of a hydroxyl group-containing polymer having “7 mass % (4.7 mol %) of a structural unit derived from acrylic acid” and “93 mass % (95.3 mol %) of a structural unit derived from vinyl alcohol”.

Since the hydroxyl group-containing polymer CP-1 had hygroscopicity, it was hermetically stored in a container having a water vapor barrier property. Note that when a powder of the hydroxyl group-containing polymer CP-1 was subjected to IR measurement, and the degree of neutralization was determined from the intensity ratio of the peak derived from C═O group of the carboxylic acid to the peak derived from C═O of the Li carboxylate, the degree of neutralization was 90 mol %.

### Production Example 3: Production of Hydroxyl Group-Containing Polymer CP-2

The same procedure as in Production Example 2 was carried out except that a monomer solution was prepared with 7.6 parts of MA and 12.4 parts of VAc, and a mixed solution of 30.4 parts of MA and 49.6 parts of VAc was added dropwise with a dropping funnel over 4 hours. The polymerization ratios of the monomers were MA: 95% and VAc: 87%.

Saponification was performed in the same manner as in Production Example 2 to obtain a saponified product of a copolymer of MA and VAc (hereinafter, also referred to as a “hydroxyl group-containing polymer CP-2”). Here, based on the polymerization ratios of MA and VAc, the hydroxyl group-containing polymer CP-2 is a lithium salt of a hydroxyl group-containing polymer having “51 mass % (40.1 mol %) of a structural unit derived from acrylic acid” and “49 mass % (59.9 mol %) of a structural unit derived from vinyl alcohol”.

Since the hydroxyl group-containing polymer CP-2 had hygroscopicity, it was hermetically stored in a container having a water vapor barrier property. Note that when a powder of the hydroxyl group-containing polymer CP-2 was subjected to IR measurement, and the degree of neutralization was determined from the intensity ratio of the peak derived from C═O group of the carboxylic acid to the peak derived from C═O of the Li carboxylate, the degree of neutralization was 90 mol %.

### Example 1

### Preparation of Binder Coating Film

In a container, a 8% aqueous solution prepared by adding ion-exchanged water to the carboxyl group-containing crosslinked polymer salt P-1 as the polymer (A) and polyvinyl alcohol PVA-1 (manufactured by Kuraray Co., Ltd., Kuraray Poval 28-98 (degree of saponification: 98 mol %), degree of polymerization: 1700) as the polymer (B) was added in the parts shown in Table 1, and then mixed at 2200 rpm for 7 minutes with a planetary centrifugal mixer (Awatori Rentaro ARE-310 manufactured by THINKY CORPORATION) to obtain a binder aqueous dispersion liquid.

Thereafter, the binder aqueous solution was poured into a disposable tray, dried at 40° C. for 20 hours, and further vacuum-dried at 80° C. for 12 hours.

The binder coating film obtained after drying was punched into a No. 8 dumbbell (JIS K6251) size to prepare a test piece, and the toughness was measured.

Here, the Rc value was calculated as follows.

$$Rc value = {m}_{A} / ( {m}_{A} + {m}_{B} )$$

m_{A}: the number of moles of carboxyl groups of polymer (A)
m_{B}: the number of moles of hydroxyl groups of polymer (B)

$${m}_{A} = ( ( the parts of solid content blending amount of P - 1 : 9 parts ) \times ( mass \% of structural unit derived from acrylic acid : 100 \% ) / 100 ) / ( ( molecular weight of structural unit derived from acrylic acid : 72.06 ) \times ( 1 - ( degree of neutralization of P - 1 : 90 mol \% ) / 100 ) \text{} + ( molecular weight of structural unit derived from lithium acrylate \text{} : 78. ) \times ( neutralization degree of P - 1 : 90 mol \% ) / 100 ) ) = 0.12$$

$${m}_{B} = ( ( the parts of solid content blending amount of PVA - 1 : 11 parts ) \times ( mass \% of structural unit derived from vinyl acetate : 100 \% ) / 100 ) / ( ( molecular weight of structural unit derived from vinyl acetate : 86.09 ) \times ( 1 - ( degree of saponification of PVA - 1 : 98 mol \% ) / 100 ) + ( molecular weight of structural unit derived from vinyl alcohol : 44.05 ) \times ( degree of saponification of PVA - 1 : 98 mol \% ) / 100 ) ) = 0.25$$

Therefore, Rc value=0.12/(0.12+0.25)=0.32 was calculated.

### Toughness of Binder Coating Film

The test piece prepared by punching out the binder coating film was subjected to a tensile test at a speed of 7.5 mm/min using a tensile tester (Tensilon RTC-1210A manufactured by ORIENTEC CO., LTD.). As a result, the maximum stress was 62 MPa, the elongation at break was 1.2%, and Young's modulus was 5.1 GPa.

In addition, the tensile product was calculated from the following formula and used as an index of toughness.

$$Tensile product ( MPa \cdot \% ) = maximum stress ( MPa ) \times elongation at break ( \% )$$

### Examples 2 to 7 and Comparative Examples 1 to 5

A binder coating film was prepared and evaluated for toughness by performing the same operations as in Example 1 except that formulation was changed as shown in Table 1. The results are shown in Table 1. Note that calculation of the Rc value was performed in the same manner as in Example 1.

Note that in Comparative Examples 1 and 5, since a binder coating film was not obtained, and the tensile test could not be performed, it was described as “unmeasurable” in Table 1.

TABLE 1

| | | | Examples and Compartive Examples No. | | | | | | |
|---|---|---|---|---|---|---|---|---|---|
| | | | Example | Example | Example | Example | Example | Example | Example |
| | | | 1 | 2 | 3 | 4 | 5 | 6 | 7 |
| Electrode | Polymer (A) | P-1 | 9 | 7 | | | | | |
| binder | (Parts of | P-2 | | | | 10 | 15 | 10 | 10 |
| | solid content) | P-3 | | | 4 | | | | |
| | Polymer (B) | PVA-1 | 11 | 13 | | 10 | 5 | | |
| | (Parts of | PVA-2 | | | | | | 10 | |
| | solid content) | PVA-3 | | | | | | | 10 |
| | | CP-1 | | | 16 | | | | |
| | | CP-2 | | | | | | | |
| | Re value | | 0.32 | 0.24 | 0.10 | 0.38 | 0.65 | 0.38 | 0.41 |
| Evaluation | Toughness | Maximum stress | 62 | 108 | 52 | 136 | 117 | 134 | 90 |
| results | of binder | (MPa) | | | | | | | |
| | coating | Elongation | 1.2 | 3.5 | 1.0 | 8.1 | 6.9 | 8.5 | 7.7 |
| | film | at break | | | | | | | |
| | | (%) | | | | | | | |
| | | Young's modulus | 5.1 | 6.1 | 5.5 | 5.4 | 50 | 5.2 | 3.1 |
| | | (GPa) | | | | | | | |
| | | Tensile product | 74 | 378 | 52 | 1,101 | 811 | 1,135 | 694 |
| | | (MPa · %) | | | | | | | |
| | Cycle | Negative electrode | B | A | B | A | A | A | A |
| | characteristics | plate 1 | | | | | | | |
| | of secondary | (SiO in total | | | | | | | |
| | battery | amount of active | | | | | | | |
| | | material: 60 mass %) | | | | | | | |
| | | Negative electrode | C | B | C | A | A | A | B |
| | | plate 2 | | | | | | | |
| | | (SiO in total | | | | | | | |
| | | amount of active | | | | | | | |
| | | material: 33 mass %) | | | | | | | |

| | | | Examples and Compartive Examples No. | | | | |
|---|---|---|---|---|---|---|---|
| | | | Compartive | Compartive | Compartive | Compartive | Compartive |
| | | | Example 1 | Example 2 | Example 3 | Example 4 | Example 5 |
| Electrode | Polymer (A) | P-1 | 20 | | | | |
| binder | (Parts of | P-2 | | 20 | | | |
| | solid content) | P-3 | | | | | |
| | Polymer (B) | PVA-1 | | | 20 | | |
| | (Parts of | PVA-2 | | | | | |
| | solid content) | PVA-3 | | | | | |
| | | CP-1 | | | | 20 | |
| | | CP-2 | | | | | 20 |
| | Re value | | 1.00 | 1.00 | 0.00 | 0.047 | 0.40 |
| Evaluation | Toughness | Maximum stress | unmea- | 20 | 115 | 70 | unmea- |
| results | of binder | (MPa) | surable | | | | surable |
| | coating | Elongation | | 0.1 | 22 | 8.0 | |
| | film | at break | | | | | |
| | | (%) | | | | | |
| | | Young's modulus | | 7.8 | 3.4 | 3.6 | |
| | | (GPa) | | | | | |
| | | Tensile product | — | 2 | 2.530 | 560 | — |
| | | (MPa · %) | | | | | |
| | Cycle | Negative electrode | D | D | D | D | D |
| | characteristics | plate 1 | | | | | |
| | of secondary | (SiO in total | | | | | |
| | battery | amount of active | | | | | |
| | | material: 60 mass %) | | | | | |
| | | Negative electrode | D | D | D | D | D |
| | | plate 2 | | | | | |
| | | (SiO in total | | | | | |
| | | amount of active | | | | | |
| | | material: 33 mass %) | | | | | |

Details of the compounds used in Table 1 are shown below.
P-2: polyacrylic acid (manufactured by Sigma-Aldrich, polyacrylic acid aqueous solution (solid content concentration: 35 mass %), weight average molecular weight: 100,000)
P-3: sodium polyacrylate (manufactured by Toagosei Co., Ltd., sodium polyacrylate aqueous solution (solid content concentration: 43 mass %), ARON (registered trademark) A-20L, weight average molecular weight: 1,000,000)
PVA-1: polyvinyl alcohol (manufactured by Kuraray Co., Ltd., Kuraray Poval 28-98 (degree of saponification: 98 mol %), degree of polymerization: 1700)
PVA-2: polyvinyl alcohol (manufactured by Kuraray Co., Ltd., Kuraray Poval 60-98 (degree of saponification: 98 mol %), degree of polymerization: 2400)
PVA-3: polyvinyl alcohol (manufactured by JAPAN VAM & POVAL CO., LTD., JL-18E (degree of saponification: 83 to 86 mol %), degree of polymerization: 1500)

### Example 1

### Preparation of Composition 1 for Negative Electrode Mixture Layer

As the active material, graphite (manufactured by Showadenkosya Co., Ltd., trade name “SCMG-CF”) and a Si-based active material (SiO 5 μm manufactured by OSAKA Titanium technologies Co., Ltd.) were used. Acetylene black (Li-400 manufactured by Denka Company Limited) was used as the conductive auxiliary agent. As the binder, a mixture of the carboxyl group-containing crosslinked polymer salt P-1 as the polymer (A) and hydroxyl group-containing polymer PVA-1 as the polymer (B) was used.

Graphite, Si-based active material, acetylene black, binder (P-1/PVA-1=9/11; Rc value: 0.32) were added in a mass ratio of graphite:Si-based active material:acetylene black:binder=30/45/5/20 (solid content) using ion-exchanged water as a diluent solvent to a planetary mixer (HIVIS MIX 2P-03 manufactured by PRIMIX Corporation) so that the solid content concentration of the composition for the negative electrode mixture layer was 37 mass %, and mixed for 1 hour and 30 minutes to prepare a composition 1 for a negative electrode mixture layer in a slurry state.

### Preparation of Composition 2 for Negative Electrode Mixture Layer

A composition 2 for a negative electrode mixture layer in a slurry state was prepared in the same manner as in the composition 1 for the negative electrode mixture layer except that a mass ratio of graphite:Si-based active material:acetylene black:binder (P-1/PVA-1 =9/11; Rc value: 0.32)=50/25/5/20 (solid content).

### Preparation of Negative Electrode Plate 1

Subsequently, the composition 1 for the negative electrode mixture layer was applied onto a current collector (copper foil) having a thickness of 16.5 μm using a variable applicator, and dried in a ventilation dryer at 80° C. for 15 minutes to form a mixture layer. Thereafter, the mixture layer was rolled to have a thickness of 43 um and a mixture density of 2.30±0.10 g/cm³, and then punched into a 3 cm square to obtain a negative electrode plate 1.

### Preparation of Negative Electrode Plate 2

A negative electrode plate 2 was obtained in the same manner as in the negative electrode plate 1 except that the composition 2 for the negative electrode mixture layer was used, the thickness of the mixture layer was 30 μm, and the mixture density was 1.60±0.10 g/cm³.

### Preparation of Positive Electrode Plate

In an N-methylpyrrolidone (NMP) solvent, 100 parts of LiNi_{0.5}Co_{0.2}Mn_{0.3}O₂ (NCM) as a positive electrode active material and 2 parts of acetylene black were mixed and added, and 4 parts of polyvinylidene fluoride (PVDF) as a binder for a positive electrode were mixed to prepare a composition for a positive electrode mixture layer. The composition for the positive electrode mixture layer was applied to an aluminum current collector (thickness: 20 μm) and dried to form a mixture layer. Thereafter, the mixture layer was rolled to have a thickness of 125 μm and a mixture density of 3.0 g/cm², and then punched into a 3 cm square to obtain a positive electrode plate.

### Preparation of Electrolytic Solution

To a mixed solvent containing ethylene carbonate (EC) and dimethyl carbonate (DMC) (EC:DMC=3:7 by volume), vinylene carbonate (VC) and fluoroethylene carbonate (DMC) were respectively added to be 1 mass % and 2 mass %, and 1.2 mol/liter of LiPF₆ was dissolved to prepare a nonaqueous electrolyte.

### Preparation of Secondary Battery

As for configuration of the battery, a lead terminal was attached to each of the positive and negative electrodes, and electrode bodies opposed to each other with a separator (made of polyethylene: film thickness 16 μm, porosity 47%) interposed therebetween were placed in a battery exterior body using an aluminum laminate, injected with liquid, and sealed to obtain a test battery. Note that a design capacity of this prototype battery is 50 mAh. As the design capacity of the battery, the battery was designed based on an end-of-charge voltage up to 4.2 V.

Note that as the negative electrode, the negative electrode plate 1 and the negative electrode plate 2 were used, and a secondary battery including each of the negative electrode plate 1 and the negative electrode plate 2 was produced.

### Evaluation of Cycle Characteristics

The lithium ion secondary battery of a laminate type cell prepared above was subjected to a charging and discharging operation at a charge-discharge rate of 0.1 C under the condition of 2.5 to 4.2 V by CC discharge under an environment of 45° C., and an initial capacity C₀ was measured. Further, charging and discharging were repeated at a charge-discharge rate of 0.5 C under the condition of 2.5 to 4.2 V by CC discharge under an environment of 25° C., and a capacity C₁₀₀ after 100 cycles was measured.

Here, the cycle characteristics (AC) were determined by the following formula.

$$Δ C = {C}_{100} / {C}_{0} \times 100 ( \% )$$

ΔC calculated by the above formula was 86.4%, and the cycle characteristics based on the following criteria were evaluated as “A”.

Note that as the value of ΔC is larger, the cycle characteristics are more excellent.

### Determination Criteria for Cycle Characteristics

A: Charge-discharge capacity retention ratio is 86.0% or more
B: Charge-discharge capacity retention ratio is 85.0% or more and less than 86.0%
C: Charge-discharge capacity retention ratio is 84.0% or more and less than 85.0%
D: Charge-discharge capacity retention ratio is less than 83.0%

### Examples 2 to 7 and Comparative Examples 1 to 5

A composition 1 for a negative electrode mixture layer and a composition 2 for a negative electrode mixture layer were each prepared by the same operation as in Example 1 except that the formulation was changed as shown in Table 1, and the cycle characteristics of secondary batteries each including a negative electrode plate 1 or a negative electrode plate 2 obtained using each composition were evaluated. The results are shown in Table 1.

### Evaluation Results

As is apparent from the results of Examples 1 to 7, the electrode binder of the present invention was excellent in toughness of the binder coating film, and excellent in cycle characteristics of the secondary battery including the secondary battery negative electrode obtained from the composition for the secondary battery negative electrode mixture layer containing the electrode binder of the present invention and the silicon-based active material.

Focusing on the tensile product of these binder coating films, when the tensile product exceeded 50 (Examples 1 to 7), the cycle characteristics of the secondary battery were good (evaluation C or higher). In particular, when the tensile product exceeded 300 (Examples 2 and 4 to 7), the cycle characteristics of the secondary battery were excellent (evaluation B or higher). Further, when the tensile product exceeded 800 (Examples 4 to 6), the cycle characteristics of the secondary battery were more excellent (evaluation A).

Here, even when an electrode binder containing the polymer (A) and, as the polymer (B), the hydroxyl group-containing polymer CP-1 having a carboxyl group and a hydroxyl group in the same molecule “copolymer of vinyl alcohol and an ethylenically unsaturated carboxylic acid alkali metal neutralized product (carboxyl group/hydroxyl group=4.7/95.3 (molar ratio))” was used (Example 3), the cycle characteristics of the secondary battery were evaluation C. This is considered to be because concentration of carboxyl group in the CP-1 was low (<5 mol %), and after coating and drying of the composition, the intermolecular interaction between the carboxyl group and the hydroxyl group of other molecules was dominant as compared with the pseudo cyclic crosslinked structure in the molecule due to the interaction between the carboxyl group and the hydroxyl group in the same molecule, and thus the binder coating film was toughened.

On the other hand, when an electrode binder not containing the polymer (B) but containing the polymer (A) was used (Comparative Examples 1 and 2), the toughness of the binder coating film was poor and the cycle characteristics were also poor (evaluation D). In Comparative Example 1, the binder coating film was brittle and the tensile test could not be performed.

When an electrode binder not containing the polymer (A) but containing polyvinyl alcohol as the polymer (B) was used (Comparative Example 3), it showed high toughness with a tensile product of 2,530 MPa, but the cycle characteristics were remarkably poor (evaluation D). This is considered to be because, due to foaming property of polyvinyl alcohol, a large number of minute voids were generated in the negative electrode mixture layer, and in addition, as compared with the polymer (A), a stable solid electrolyte interphase (SEI) on a surface of the silicon-based active material was not formed, and the silicon-based active material was finely pulverized as it expanded and contracted during charging and discharging.

Furthermore, when an electrode binder not containing the polymer (A) but containing, as the polymer (B), the hydroxyl group-containing polymer CP-1 having a carboxyl group and a hydroxyl group in the same molecule “copolymer of vinyl alcohol and an ethylenically unsaturated carboxylic acid alkali metal neutralized product (carboxyl group/hydroxyl group=4.7/95.3 (molar ratio))” was used (Comparative Example 4), it showed high toughness with a tensile product of 560, but the cycle characteristics were remarkably poor (evaluation D). This is considered to be because a large number of fine voids were generated in the negative electrode mixture layer due to foaming property of the CP-1.

Furthermore, when an electrode binder not containing the polymer (A) but containing, as the polymer (B), the hydroxyl group-containing polymer CP-2 having a carboxyl group and a hydroxyl group in the same molecule “copolymer of vinyl alcohol and an ethylenically unsaturated carboxylic acid alkali metal neutralized product (carboxyl group/hydroxyl group=40.1/59.9 (molar ratio))” was used (Comparative Example 5), the binder coating film was brittle, the tensile test could not be performed, and the cycle characteristics of the secondary battery were also poor (evaluation D). This is considered to be because when the electrode binder not containing polymer (A) but containing, as the polymer (B), the hydroxyl group-containing polymer CP-2 was used, since water was removed after drying, a pseudo cyclic crosslinked structure was preferentially generated in the molecule by the interaction between the carboxyl group and the hydroxyl group in the same molecule, and thus the toughness of the binder coating film was reduced by increase in rigidity of a main chain, that is, reduction in entanglement of a polymer chain, so that the binder coating film could not follow expansion and contraction of the silicon-based active material.

### INDUSTRIAL APPLICABILITY

The electrode binder of the present invention is excellent in toughness of the binder coating film, and the secondary battery including the secondary battery negative electrode obtained using an electrode slurry containing the binder and the silicon-based active material can ensure good integrity, and exhibits good durability (cycle characteristics) even when charging and discharging are repeated, and thus it is expected to contribute to an increase in capacity of an in-vehicle secondary battery or the like.

The electrode binder of the present invention can be particularly suitably used for a nonaqueous electrolyte secondary battery electrode, and is particularly useful for a nonaqueous electrolyte lithium ion secondary battery having a high energy density.

1. An electrode binder for a secondary battery including a secondary battery negative electrode containing a silicon-based active material, the binder comprising a carboxyl group-containing polymer or a salt thereof (hereinafter, referred to as “polymer (A)”) and a hydroxyl group-containing polymer (different from the “polymer (A)”, hereinafter, referred to as “polymer (B)”) optionally having a carboxyl group or a salt thereof.

2. The electrode binder according to claim 1, wherein an Rc value calculated by a formula (1) below based on the number of moles (hereinafter, referred to as “mA”) of carboxyl groups of the polymer (A) and the number of moles (hereinafter, referred to as “mB”) of hydroxyl groups of the polymer (B) is 0.1 or more and 0.9 or less.
$$Rc value = mA / ( mA + mB ) \qquad ( 1 )$$

3. The electrode binder according to claim 1, wherein the polymer (A) contains a structural unit derived from an ethylenically unsaturated carboxylic acid monomer in an amount of 40 mass % or more and 100 mass % or less with respect to all structural units of the polymer (A).

4. The electrode binder according to claim 1, wherein the polymer (B) has a structural unit derived from vinyl alcohol.

5. The electrode binder according to claim 1, wherein the polymer (B) has a carboxyl group or a salt thereof, and a molar ratio of the carboxyl group to the hydroxyl group is 5/95 or less.

6. An electrode binder, wherein a tensile product of a binder coating film obtained from the electrode binder according to claim 1 is 50 or more as a value calculated by a formula (2) below.
$$Tensile product ( MPa \cdot \% ) = maximum stress ( MPa ) \times elongation at break ( \% ) \qquad ( 2 )$$

7. The electrode binder according to claim 1, wherein a content of the silicon-based active material is 30 mass % or more with respect to a total amount of the active material.

8. A composition for a secondary battery negative electrode mixture layer, the composition comprising the electrode binder according to claim 1, a silicon-based active material, and water.

9. A secondary battery negative electrode comprising a mixture layer formed of the composition for the secondary battery negative electrode mixture layer according to claim 8 on a surface of a current collector.

10. A secondary battery comprising the secondary battery negative electrode according to claim 9.
